(19) United States
(12) Patent Application Publication
(10) Pub. No.: US 2020/0197834 A1
(43) Pub. Date: Jun. 25, 2020

(54) COMPOSITE HOLLOW FIBER MEMBRANES FOR JET FUEL DE-OXYGENATION

(71) Applicant: AIR LIQUIDE ADVANCED TECHNOLOGIES U.S. LLC, Houston, TX (US)

(72) Inventors: Yong DING, Waban, MA (US); Benjamin BIKSON, Newton, MA (US); Joyce K. NELSON, Lexington, MA (US)

(73) Assignee: AIR LIQUIDE ADVANCED TECHNOLOGIES U.S. LLC, Houston, TX (US)

(21) Appl. No.: 16/724,173

(22) Filed: Dec. 20, 2019

Related U.S. Application Data
(60) Provisional application No. 62/784,409, filed on Dec. 22, 2018.

(51) Int. Cl. B01D 19/00; B01D 53/22; C10G 31/06; C10G 31/11

(52) U.S. Cl. CPC B01D 19/0031; B01D 53/22; B01D 2053/224; C10G 31/11; B01D 2257/104; C10G 31/06

(57) ABSTRACT

A liquid hydrocarbon fuel containing dissolved oxygen is at least partially deoxygenated with a membrane device comprising a composite hollow fiber membrane that is comprised of an ultra-thin amorphous fluoropolymer layer superimposed on a porous PEEK polymer substrate.

### CROSS-REFERENCE TO RELATED APPLICATIONS

This application claims the benefit of U.S. Provisional Application No. 62/784,409, filed Dec. 22, 2018.

### BACKGROUND

### Field of the Invention

The invention pertains to methods and apparatuses for jet fuel deoxygenation using composite hollow fiber membrane comprised of an amorphous fluoropolymer layer superimposed on a porous poly(aryl ether ketone), i.e., PAEK, polymer substrate.

### Related Art

The jet fuel on board aircraft is frequently used as a heat transfer fluid in heat exchangers for cooling purposes as a replacement to ram air. As flight speeds for advanced aircraft, rocket, and missiles increase to the high supersonic and hypersonic regime, the temperature of the ram air taken on board the vehicle becomes too high to cool aircraft systems. Therefore, it is increasingly necessary to utilize the fuel as the primary coolant.

One of the consequences of using jet fuel as a coolant in high performance aircraft is the production of carbonaceous deposits that result from the autoxidation of the fuel by oxygen that is dissolved in the fuel. These deposits cause fouling of critical aircraft components and can lead to catastrophic failure of the engine system. When air-saturated fuel is heated to temperatures above about 120° C. (250° F.) or above about 150° C. (300° F.), the dissolved oxygen forms free radical species (coke precursors) which initiate and propagate other autoxidation reactions that in turn lead to the formation of objectionable deposits, called “coke” or “coking”. As fuel temperature increases beyond the autoxidation temperature (typically about 150° C. (300° F.)), the process of autoxidation consumes oxygen and forms carbonaceous deposits. The temperature at which autoxidation begins depends upon which fuel is being heated. It should be noted that these autoxidation reactions may also occur in jet fuel as it is heated immediately prior to injection for combustion, such that deposits may occur in the injectors. In any event, the formation of carbonaceous deposits impairs the normal function of the fuel delivery system, either with respect to an intended heat exchange function or the efficient injection of the fuel.

Many attempts have been made to solve the problem of oxidation of liquid hydrocarbons. U.S. Pat. No. 8,388,740 discloses the application of oxygen-free gas for removal of the oxygen from the hydrocarbon fuel mixture. The introduction of additives into liquid hydrocarbons has been used successfully for many years. For example, U.S. Pat. No. 5,382,266 discloses the application of phosphine and phosphates to distillate fuels to prevent fuel degradation (such as color degradation, particulate formation, and/or gum formation). U.S. Pat. No. 5,509,944 discloses the stabilization of gasoline through addition of an effective amount of a primary antioxidant, such as phenylene diamine, a hindered monophenol, or mixtures of these, and also a secondary antioxidant, such as dimethyl sulfoxide. U.S. Pat. No. 5,362,783 discloses the combination of phosphine and hindered phenols as a stabilizer in thermoplastic polymers to prevent discoloration. U.S. Pat. No. 6,475,252 discloses an additive composition comprising a hindered phenol, a peroxide decomposer, and a phosphine compound for prevention of oxidation and peroxide formation.

The U.S. Air Force JP-8+100 program developed an additive package for jet fuel that significantly increases the thermal stability of the fuel by preventing the formation of deposits resulting from fuel oxidation within aircraft fuel systems. See Heneghan, S. P., Zabarnick, S., Ballal, D. R., Harrison, W. E., J. Energy Res. Tech. 1996, 118, 170-179; and Zabarnick, S., and Grinstead, R. R., Ind. Eng. Chem. Res. 1994, 33, 2771-2777. The JP-8+100 jet fuel incorporates additives for providing thermal stability to 425° F. At high temperatures (>425°), however, the JP-8+100 additive package loses effectiveness either due to temperature induced failure of the active mechanisms or due to the thermal degradation of the additive compounds themselves.

Thus, while laboratory testing and field implementation of JP-8+100 have been very successful at temperatures up to 425° F., application of similar additive technologies to achieve thermal stabilities on the order of 900° F. is considered unlikely. The difficulty does not lie in the approach, because modifying a fuel through the addition of additives remains a cost-effective and efficient method for tailoring a fuel to specific temperature requirements. Rather, the difficulty lies in the fundamental limits imposed by high-temperature chemistry since fuel molecules decompose at high temperatures. It remains to be seen whether an improved jet fuel additive will be developed that will inhibit the oxidation of the fuel at high temperatures (>425° F.).

A fuel stabilization unit that reduces the amount of oxygen dissolved within the fuel is needed. Reducing the amount of oxygen in the fuel increases the maximum allowable exposure temperature of the fuel, thereby increasing its heat sink capacity when used for cooling components onboard the aircraft.

One method of removing dissolved oxygen from fuels is by using a semi-permeable membrane deoxygenator. In a membrane deoxygenator, fuel is pumped over an oxygen permeable membrane. As the fuel passes over the membrane, a partial oxygen pressure differential across the membrane is generated that promotes the transport of oxygen out of the fuel through the membrane. Exemplary deoxygenators remove oxygen to a level at least below that at which significant coking would otherwise occur. As used herein, “significant coking” is the minimum amount of coking which, if it occurred in the interval between normal intended maintenance events for such portions of the fuel system, would be viewed as objectionable. Such coking occurs most readily in the portions of the fuel system having high temperatures and/or constricted flow paths.

U.S. Pat. No. 6,315,815 discloses the use of a membrane filter for removal fo oxygen from the liquid fuel. The membrane is formed from PTFE polymer. However, the disclosed membrane filter exhibits an extremely low oxygen removal rate and thus is inefficient for oxygen removal. Furthermore, a high rate of fuel loss through evaporation occurs during the deoxygenation process due to the porous nature of the membrane. U.S. Pat. No. 7,175,693 discloses a method for removal of oxygen from the liquid fuel by using a composite membrane from PVDF substrate superimposed with an amorphous Teflon layer, such as AF2400. However, the PVDF substrate is formed by the phase inversion method from a solution which makes the composite membrane unstable once in contact with liquid fuels that contain significant amount of aromatic hydrocarbons.

U.S. Pat. Nos. 7,393,388, 7,465,335, 7,465,336, 7,615,104, 7,824,470 and 8,177,814 disclose methods of oxygen removal from liquid hydrocarbon fuel using flat sheet or textured plate membranes. However, these methods suffer from an inefficient mass transfer of oxygen. The excessive size and weight of the device needed to overcome this inefficiency limits its use on board aircraft where every bit of mass and volume counts.

U.S. Pat. No. 5,876,604 discloses the use of amorphous Teflon formed from an amorphous copolymer of perfluoro-2,2-dimethyl-1,3-dioxole for gasifying or degassing a liquid. However, the disclosed membrane configurations and substrates are compatible with only a limited number of liquids such as water and blood. Thus, they are not suitable for the removal of oxygen from jet fuel since jet fuel contains liquid hydrocarbons.

In view of the foregoing discussion, there is a need for an improved solution for inhibiting or preventing thermal degradation of jet fuel that is not limited to temperatures less than 425° F. There is also a need for an improved solution for inhibiting or preventing thermal degradation of jet fuel whose components in contact with jet fuel don't exhibit failure upon such contact. There is also a need for an improved solution for inhibiting or preventing thermal degradation of jet fuel whose size and weight do not limit their use aboard aircraft.

### SUMMARY

There is disclosed a method for producing oxygen-depleted liquid hydrocarbon fuel for combustion in an energy conversion device in which the oxygen-depleted liquid hydrocarbon fuel is used as a cooling medium that includes the following steps. A flow of liquid hydrocarbon fuel containing dissolved oxygen is fed into a membrane device comprising a composite hollow fiber membrane that is comprised of a porous PAEK substrate with a thin layer of an amorphous perfluoro polymer superimposed thereon. The fed flow of dissolved oxygen-containing liquid hydrocarbon fuel is allowed to come into contact with a first side of the membrane, thereby permeating at least some of the dissolved oxygen across the membrane from the first side to a second side of the membrane. A flow of at least partially deoxygenated liquid hydrocarbon fuel is withdrawn from the membrane device that is depleted of dissolved oxygen in comparison to the flow of the dissolved oxygen-containing liquid hydrocarbon fuel that is fed to the membrane device. A gas stream is withdrawn from the membrane device containing the permeated oxygen that is removed from the fed flow of the dissolved oxygen-containing liquid hydrocarbon fuel.

There is disclosed an apparatus for removing amounts of dissolved oxygen from a flow of dissolved oxygen-containing liquid hydrocarbon fuel for an energy conversion device, comprising: a tank containing dissolved oxygen-containing liquid hydrocarbon fuel, said tank being adapted and configured to contain an amount of the dissolved oxygen-containing liquid hydrocarbon fuel; a first liquid pump in upstream flow communication with said tank; a membrane device in upstream flow communication with said first liquid pump and comprising a pressure vessel having a feed inlet, a permeate gas outlet, and a deoxygenated liquid hydrocarbon fuel outlet, contained within the pressure vessel is a composite hollow fiber membrane that is comprised of a porous PAEK substrate with a thin layer of an amorphous perfluoro polymer superimposed thereon, wherein: said first pump is adapted and configured to pump a flow of dissolved oxygen-containing liquid hydrocarbon fuel from said tank, said membrane device is adapted and configured to place the flow of dissolved oxygen-containing liquid hydrocarbon fuel in contact with a first side of said composite hollow fiber membrane, and said membrane device being adapted and configured to selectively permeate amounts of oxygen from the dissolved oxygen-containing liquid hydrocarbon from the first side of the composite hollow fiber membrane to a second side of the composite hollow fiber membrane to yield a flow of permeate gas containing the permeated oxygen from said permeate gas outlet and a flow of deoxygenated liquid hydrocarbon fuel from said deoxygenated liquid hydrocarbon fuel outlet.

An aircraft fueled by at least partially deoxygenated liquid jet fuel, comprising an apparatus for removing amounts of dissolved oxygen from a flow of dissolved oxygen-containing liquid hydrocarbon fuel for an energy conversion device, comprising: a tank containing dissolved oxygen-containing liquid hydrocarbon fuel, said tank being adapted and configured to contain an amount of the dissolved oxygen-containing liquid hydrocarbon fuel; a first liquid pump in upstream flow communication with said tank; a membrane device in upstream flow communication with said first liquid pump and comprising a pressure vessel having a feed inlet, a permeate gas outlet, and a deoxygenated liquid hydrocarbon fuel outlet, contained within the pressure vessel is a composite hollow fiber membrane that is comprised of a porous PAEK substrate with a thin layer of an amorphous perfluoro polymer superimposed thereon, wherein: said first pump is adapted and configured to pump a flow of dissolved oxygen-containing liquid hydrocarbon fuel from said tank, said membrane device is adapted and configured to place the flow of dissolved oxygen-containing liquid hydrocarbon fuel in contact with a first side of said composite hollow fiber membrane, and said membrane device being adapted and configured to selectively permeate amounts of oxygen from the dissolved oxygen-containing liquid hydrocarbon from the first side of the composite hollow fiber membrane to a second side of the composite hollow fiber membrane to yield a flow of permeate gas containing the permeated oxygen from said permeate gas outlet and a flow of deoxygenated liquid hydrocarbon fuel from said deoxygenated liquid hydrocarbon fuel outlet, wherein said tank is a jet fuel tank, the dissolved oxygen-containing liquid hydrocarbon fuel is jet fuel, the energy conversion device is an aircraft engine, and a flow of at least partially deoxygenated jet fuel is received by the aircraft engine from the membrane device.

The method, apparatus, or aircraft may include one or more of the following aspects:

heat is transferred from the energy conversion device, a heat sink, or a fluid to the withdrawn flow of the at least partially deoxygenated liquid hydrocarbon fuel so as to cool the energy conversion device and heat the at least partially deoxygenated liquid hydrocarbon fuel.

the deoxygenated liquid hydrocarbon fuel is heated to a temperature of at least 250° F.

the deoxygenated liquid hydrocarbon fuel is heated to a temperature of at least 300° F.

the deoxygenated liquid hydrocarbon fuel is heated to a temperature of at least 425° F.

the deoxygenated liquid hydrocarbon fuel is heated to a temperature of at least 900° F.

heat is transferred from the energy conversion device to the deoxygenated liquid hydrocarbon fuel.

a positive partial pressure differential for oxygen across the membrane from the first side to the second side is increased by applying a vacuum is applied to the second side of the membrane device.

the positive partial pressure differential for oxygen across the membrane from the first side to the second side is increased by feeding a sweep gas is fed to the second side of the membrane device.

a positive partial pressure differential for oxygen across the membrane from the first side to the second side is increased by feeding a sweep gas to the second side of the membrane device.

the sweep gas is an amount of liquid hydrocarbon fuel, before or after deoxygenation at the membrane device, that has been allowed to vaporize.

the sweep gas is: nitrogen generated by an on board air separation system; or

nitrogen or argon from an inert gas generator.

the withdrawn gas stream is directed into a head space of a fuel tank from which the flow of dissolved oxygen-containing liquid hydrocarbon fuel was obtained.

at least some of the oxygen-containing liquid hydrocarbon fuel fed to the membrane device also permeates, in the form of vapor, across the membrane from the first side to the second side along with the permeating oxygen.

the membrane is characterized by a room temperature permeance of propane of lower than 15 GPU.

the membrane is characterized by a room temperature permeance of propane of lower than 10 GPU.

the membrane is characterized by a room temperature permeance of propane of lower than 8 GPU.

the membrane is characterized by a room temperature permeance of oxygen of at least 70 GPU.

the thin layer of amorphous perfluoro polymer is superimposed upon an outer surface of the PAEK substrate.

the thin layer of amorphous perfluoro polymer is superimposed on an inner surface of the hollow fiber that forms the first side of the membrane.

the fed flow of dissolved oxygen-containing liquid hydrocarbon fuel is pumped by a pump to the membrane device at a pressure between 100 and 400 psig.

the energy conversion device is an aircraft engine;

the dissolved oxygen-containing liquid hydrocarbon fuel is jet fuel;

the fed flow of dissolved oxygen-containing liquid hydrocarbon fuel is obtained from an aircraft jet fuel tank;

the withdrawn flow of at least partially deoxygenated liquid hydrocarbon fuel is returned to the aircraft jet fuel tank.

the dissolved oxygen-containing liquid hydrocarbon fuel is jet fuel;

the withdrawn flow of at least partially deoxygenated liquid hydrocarbon fuel is fed to the aircraft engine.

the dissolved oxygen-containing liquid hydrocarbon fuel is selected from the group consisting of kerosenes, gasolines, biofuels, ethanol, and mixtures of a gasoline and ethanol.

a conduit is adapted and configured to receive heat from an energy conversion device and has first and second ends, said conduit first end being in upstream flow communication with said deoxygenated liquid hydrocarbon fuel outlet, thereby cooling the energy conversion device and heating the flow of deoxygenated liquid hydrocarbon fuel yielded by said membrane device.

a first end of a conduit also having a second end is in upstream flow communication with said deoxygenated liquid hydrocarbon fuel outlet, wherein said conduit second end is in upstream flow communication with said tank so as to direct the flow of deoxygenated liquid hydrocarbon fuel, that is yielded by said membrane device, to said tank, and said apparatus further comprises a fuel feed line having first and second ends, said fuel feed line first end being in upstream flow communication with said tank and said fuel feed line second end being adapted and configured to feed a flow of at least partially deoxygenated liquid hydrocarbon fuel from said tank to an energy conversion device.

a vacuum pump or ejector is in vacuum communication with the second side of the composite hollow fiber membrane so as to increase an oxygen partial pressure difference across the composite hollow fiber membrane from said first side to said second side.

a source of a sweep gas is in upstream flow communication with the second side of the composite hollow fiber membrane so as to increase an oxygen partial pressure difference across the composite hollow fiber membrane from said first side to said second side.

a source of a sweep gas is in upstream flow communication with the second side of the composite hollow fiber membrane so as to increase an oxygen partial pressure difference across the composite hollow fiber membrane from said first side to said second side.

said source of a sweep gas is a headspace of said tank and said sweep gas is an amount of liquid hydrocarbon fuel, before or after deoxygenation at the membrane device.

said source of a sweep gas is an air separation system adapted and configured to separate air into oxygen-enriched air and nitrogen-enriched air and said sweep gas is nitrogen-enriched air produced by said air separation system.

a conduit has first and second ends, said conduit first end being in upstream flow communication with said deoxygenated liquid hydrocarbon fuel outlet, wherein said conduit second end is adapted and configured to be placed in upstream flow communication with the energy conversion device so as to direct the flow of deoxygenated liquid hydrocarbon fuel, that is yielded by said membrane device, to the energy conversion device for combustion thereat.

the permeate gas outlet is in upstream flow communication with a head space of said tank so as to receive the flow of permeate gas, containing the permeated oxygen, from said permeate gas outlet.

a room temperature oxygen permeance of the composite hollow fiber membrane is higher than a room temperature propane permeance of the composite hollow fiber membrane.

the room temperature oxygen permeance is at least 30 GPU and no more than 5000 GPU and the room temperature propane permeance is lower than 15 GPU.

the room temperature oxygen permeance is at least 30 GPU and no more than 5000 GPU and the room temperature propane permeance is lower than 10 GPU.

the room temperature oxygen permeance is at least 30 GPU and no more than 5000 GPU and the room temperature propane permeance is lower than 8 GPU.

the thin layer of amorphous perfluoro polymer is superimposed upon an outer surface of the PAEK substrate.

the thin layer of amorphous perfluoro polymer is superimposed on an interior surface of the PAEK substrate.

the fed flow of dissolved oxygen-containing liquid hydrocarbon fuel is pumped by a pump to the membrane device at a pressure between 100 and 400 psig.

a filter is disposed in fluid communication between said pump and said membrane device and is adapted and configured to remove particulates from the flow of deoxygenated liquid hydrocarbon fuel to said membrane device.

the energy conversion device is an aircraft engine, said tank is a jet fuel tank, and the dissolved oxygen-containing liquid hydrocarbon fuel is jet fuel.

the feed inlet is disposed on an outer circumferential surface of the membrane device adjacent an upstream end of the membrane device; disposed concentrically within the pressure vessel is a hollow center tube having apertures formed therein at an upstream end of the membrane device; the deoxygenated liquid hydrocarbon fuel outlet is disposed at a downstream, axial end in downstream flow communication with an interior of the hollow center tube; the gaseous permeate outlet is disposed at a upstream, axial end of the membrane device; and the membrane device is adapted and configured to produce a flow of dissolved oxygen-containing liquid hydrocarbon fuel radially toward the composite hollow fiber membrane and axially along the composite hollow fiber membrane in an upstream to downstream direction and to produce a flow of permeate gas constituting dissolved oxygen that permeates across the composite hollow fiber membrane from the dissolved oxygen-containing liquid hydrocarbon fuel in counter-flow fashion with respect to the upstream to downstream axial flow of dissolved oxygen-containing liquid hydrocarbon fuel.

the feed inlet is disposed at an upstream, axial end of the membrane device; the deoxygenated liquid hydrocarbon fuel outlet is disposed on an outer circumferential surface of the membrane device adjacent a downstream end of the membrane device; disposed concentrically within the pressure vessel is a hollow center tube having apertures formed therein at an upstream end of the membrane device; the gaseous permeate outlet is disposed at the upstream, axial end of the membrane device; and the membrane device is adapted and configured to produce a flow of dissolved oxygen-containing liquid hydrocarbon fuel axially along the composite hollow fiber membrane in an upstream to downstream direction and to produce a flow of permeate gas constituting dissolved oxygen that permeates across the composite hollow fiber membrane from the dissolved oxygen-containing liquid hydrocarbon fuel in counter-flow fashion with respect to the upstream to downstream axial flow of dissolved oxygen-containing liquid hydrocarbon fuel.

the feed inlet of the membrane device is disposed at an upstream end of the membrane device; disposed concentrically within the pressure vessel is a hollow center tube having apertures formed therein at an upstream end of the membrane device; the gaseous permeate outlet is disposed at an axial, upstream end of the membrane device; the deoxygenated fuel outlet is disposed on an outer circumferential surface of the membrane device adjacent a downstream end of the membrane device; and the membrane device is adapted and configured to produce a flow of dissolved oxygen-containing liquid hydrocarbon fuel axially along the composite hollow fiber membrane in an upstream to downstream direction and to produce a flow of permeate gas constituting dissolved oxygen that permeates across the composite hollow fiber membrane from the dissolved oxygen-containing liquid hydrocarbon fuel in counter-flow fashion with respect to the upstream to downstream axial flow of dissolved oxygen-containing liquid hydrocarbon fuel.

### BRIEF DESCRIPTION OF THE DRAWINGS

FIG. 1 is a schematic of an apparatus of the invention.

FIG. 2 is a schematic of an embodiment of an apparatus of the invention.

FIG. 3 is a schematic of an embodiment of an apparatus of the invention.

FIG. 4 is a schematic of an embodiment of an apparatus of the invention.

FIG. 5 is a schematic of an embodiment of an apparatus of the invention.

FIG. 6 is a schematic of an embodiment of an apparatus of the invention.

FIG. 7 is a schematic of an embodiment of an apparatus of the invention.

FIG. 8 is a schematic of an embodiment of an apparatus of the invention.

FIG. 9 is a schematic of an embodiment of an apparatus of the invention.

FIG. 10 is a schematic of an embodiment of an apparatus of the invention.

FIG. 11 is a cross-sectional view of a composite hollow fiber membrane used in the invention in which a thin layer of amorphous perfluoro polymer is superimposed upon an outer surface of a PAEK substrate.

FIG. 12 is a cross-sectional view of a composite hollow fiber membrane used in the invention in which a thin layer of amorphous perfluoro polymer is superimposed upon an inner surface of a PAEK substrate.

FIG. 13 is a cross-sectional schematic diagram of one type of membrane device for use in the invention.

FIG. 14 is a schematic diagram of the membrane device of FIG. 13, with parts removed, having an inwardly, radially fed and counter-current flow pattern.

FIG. 15 is a cross-sectional schematic diagram of another type of membrane device for use in the invention

FIG. 16 is a schematic diagram of the membrane device of FIG. 15, with parts removed, having an outwardly, radially fed and counter-current flow pattern.

FIG. 17 is a cross-sectional schematic diagram of another type of membrane device for use in the invention

FIG. 18 is a schematic diagram of the membrane device of FIG. 17, with parts removed, having an outwardly, radially fed and counter-current flow pattern.

### DETAILED DESCRIPTION OF THE INVENTION

A liquid hydrocarbon fuel containing dissolved oxygen may be at least partially deoxygenated by a membrane device that includes a composite hollow fiber membrane which includes a thin layer of amorphous perfluoro polymer superimposed upon an outer surface of a porous PAEK substrate. The superior oxygen/hydrocarbon selectivity of the amorphous perfluoro polymer allows separation of the dissolved oxygen from the liquid hydrocarbon fuel. The superior flux of oxygen through the porous PAEK substrate allows for relatively high productivity of dissolved oxygen removal. After at least partial deoxygenation by the membrane device, the liquid hydrocarbon fuel may be combusted in an energy conversion device. Prior to, or concurrent with, combustion of the liquid hydrocarbon fuel by the energy conversion device, the fuel may be used to cool a heat sink, the energy conversion device itself, or a fluid in a heat exchanger.

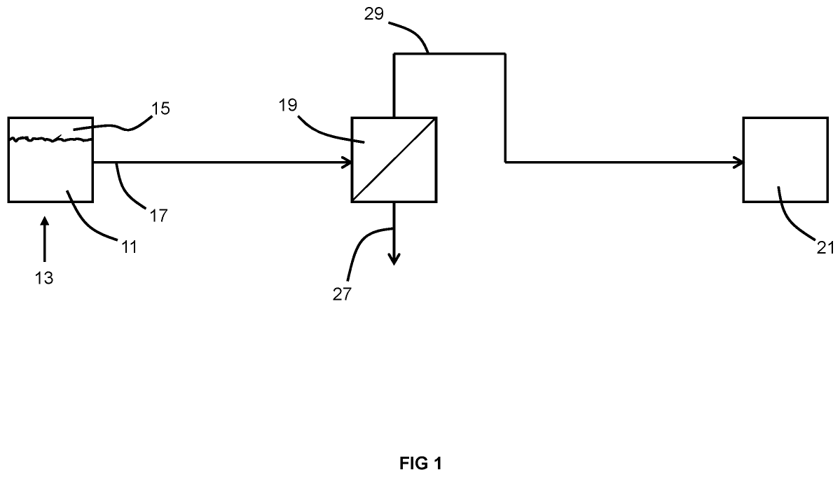

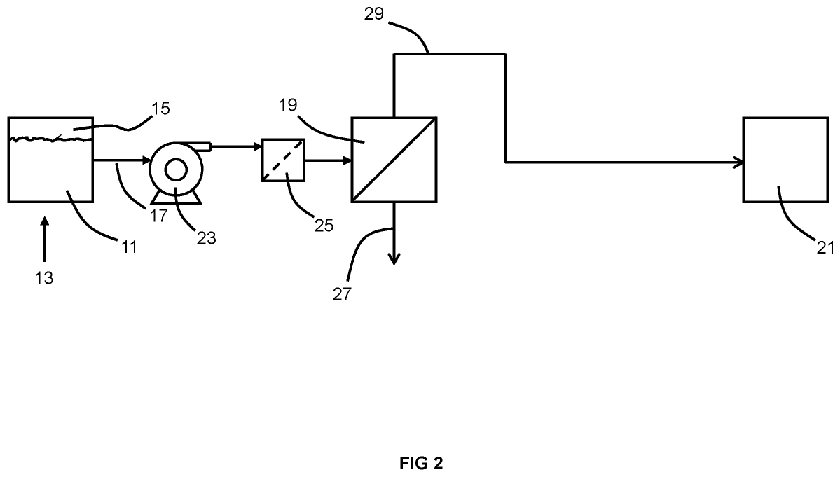

As shown in FIGS. 1-10, an amount of dissolved oxygen-containing liquid hydrocarbon fuel 11 is contained within a tank 13 in which a headspace 15 is present over the liquid hydrocarbon fuel 11. A flow 17 of the dissolved oxygen-containing liquid hydrocarbon fuel to be deoxygenated is directed towards a membrane device 19 via a conduit. Typically, the dissolved oxygen-containing liquid hydrocarbon fuel is at a pressure from about close to atmospheric pressure and up to 400 psig feed pressure. More typically, it is at a pressure of between 100 psig and 400 psig. Even more typically, it is at a pressure of between 200 psig and 300 psig. If the dissolved oxygen-containing liquid hydrocarbon fuel 11 within the tank 13 is not already at a pressure sufficient for deoxygenation at the membrane device 19 and/or sufficient for combustion at the energy conversion device 21, as seen in FIG. 2, an optional pump 23 may be used to increase the pressure of the flow 17 of dissolved oxygen-containing liquid hydrocarbon fuel fed to the membrane device 19. Optionally, a filter 25 disposed in fluid communication between, on one hand, the tank 13 (and optional pump 23 if present), and on the other hand, the membrane device 19 so that any solids may be filtered out so as to avoid fouling the membrane device 19. Although it need not be preheated, the dissolved oxygen-containing liquid hydrocarbon fuel may be preheated, prior to being received into the membrane device 19, to a temperature up to 70° C.

As illustrated in FIGS. 1-10, 13, 15, and 17, the membrane device 19 includes a tubular pressure vessel 51 having a feed inlet 53, a permeate gas outlet 55, and a deoxygenated fuel outlet 57. At the membrane device 19, the flow 17 of dissolved oxygen-containing liquid hydrocarbon fuel is received into an interior of the membrane device 19 via the feed inlet 53 and is directed into contact with a first side of a composite hollow fiber membrane inside the pressure vessel 51. The membrane includes a thin layer of amorphous perfluoro polymer superimposed on a porous PAEK substrate, wherein the thin layer of amorphous perfluoro polymer is disposed at the first side. Due to the presence of a positive oxygen partial pressure differential across the membrane from the first side to the second side and the selectivity of the membrane for oxygen over hydrocarbons, amounts of the oxygen dissolved in the fuel of flow 17 permeate across the membrane to a second side of the membrane leaving an oxygen-depleted liquid hydrocarbon fuel. Optionally, the dissolved oxygen-containing liquid hydrocarbon fuel may be fed to two or more membrane devices 19 in parallel or in series.

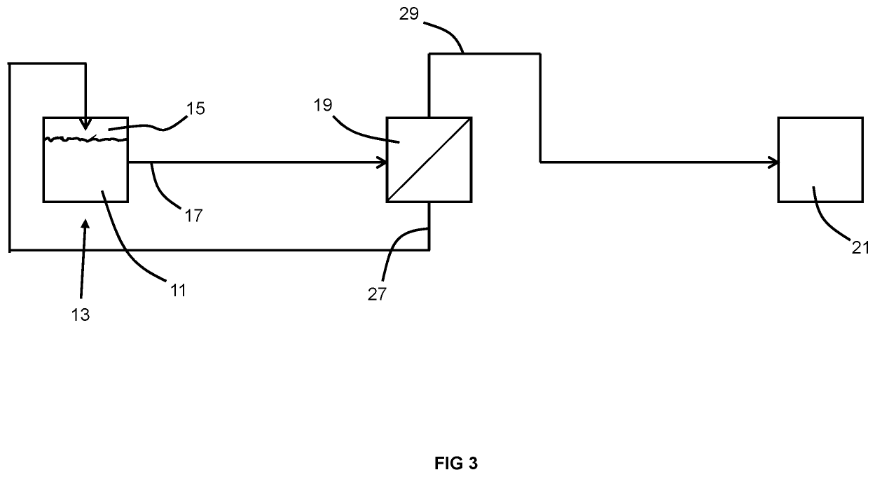

Two streams are withdrawn from the membrane device 19. The permeated oxygen is withdrawn as a flow of gaseous permeate 27 via the gaseous permeate outlet 55. Optionally and as illustrated in FIG. 3, the flow of gaseous permeate 27 may be recycled to the headspace 15 of the tank 13 so as to recover any hydrocarbon vapor that may have permeated across the membrane from the first side to the second side. Otherwise, the flow of gaseous permeate 27 may be vented or disposed of or consumed in any conventionally known manner. The at least partially deoxygenated liquid hydrocarbon fuel is withdrawn as a flow of at least partially deoxygenated liquid hydrocarbon fuel 29 via the deoxygenated fuel outlet 57. The flow of the at least partially deoxygenated liquid hydrocarbon fuel 29 is received into a conduit.

While each of the membrane devices 19 of FIGS. 13, 15, and 17 includes a pressure vessel 51 having a feed inlet 53, a permeate gas outlet 55, and a deoxygenated fuel outlet 57, these membrane devices 19 have different flow patterns.

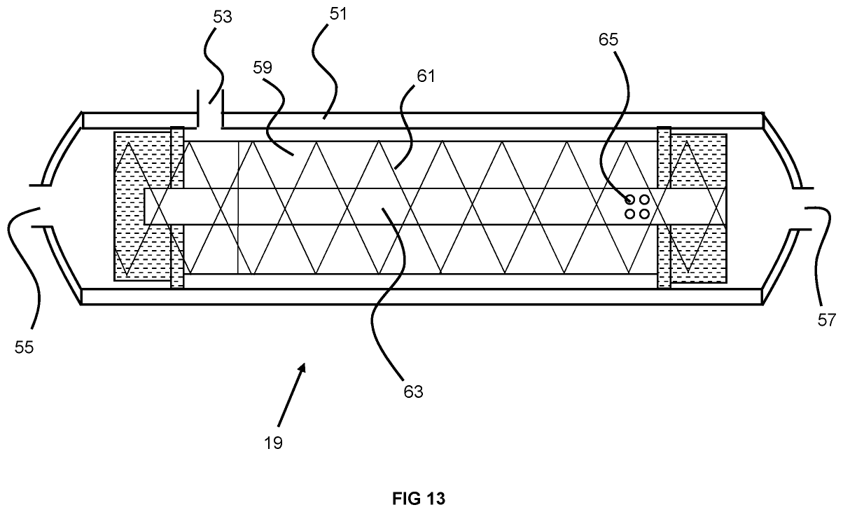

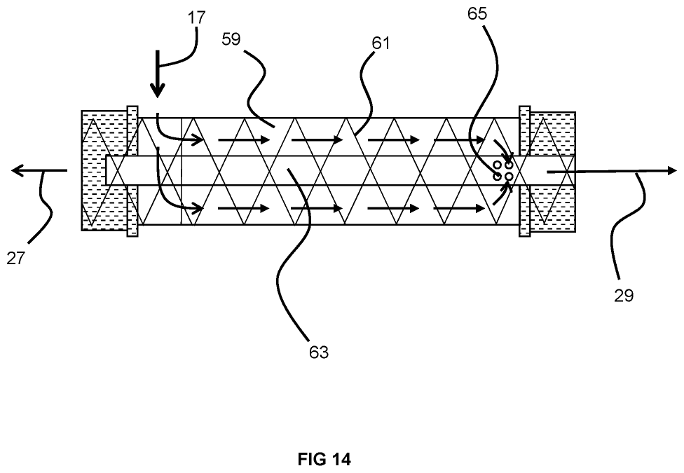

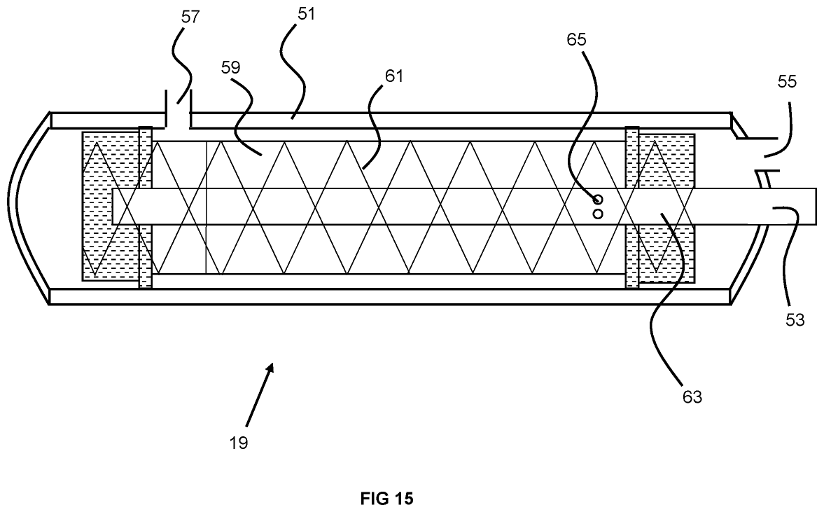

In the membrane device 19 of FIG. 13, the feed inlet 53 is disposed on an outer circumferential surface of the membrane device 19. As seen in FIG. 14, the flow 17 of dissolved oxygen-containing liquid hydrocarbon fuel enters the membrane device 19 at the feed inlet 53 and flows along the bundle 59 of composite hollow fibers 61 (illustrated stylistically here as being wound around a hollow center tube 63) from an upstream end of the bundle 59 to a downstream end of the bundle 59. After permeation of amounts of the dissolved oxygen into the bores of the composite hollow fibers 61, the at least partially deoxygenated liquid hydrocarbon fuel enters the hollow center tube 63 via apertures 65 formed in the hollow center tube 63 adjacent the upstream end of the bundle 59. The flow of at least partially deoxygenated liquid hydrocarbon fuel 29 is withdrawn via the deoxygenated fuel outlet 57 disposed at the downstream end of the membrane device 19. Those of ordinary skill in the art will recognized that upstream and downstream denote the flow direction of the liquid hydrocarbon fuel flowing across the bundle 59. The permeated oxygen flows in counter-current fashion, with respect to the flow of dissolved oxygen-containing liquid hydrocarbon fuel within the membrane device 19, to the upstream end of the membrane device and the flow of gaseous permeate 27 is withdrawn from the membrane device 19 via the gaseous permeate outlet 55. Those of ordinary skill in the art will recognize that the combination of flow patterns described above for the membrane device 19 of FIG. 13 may be considered radially inwardly fed and counter-current.

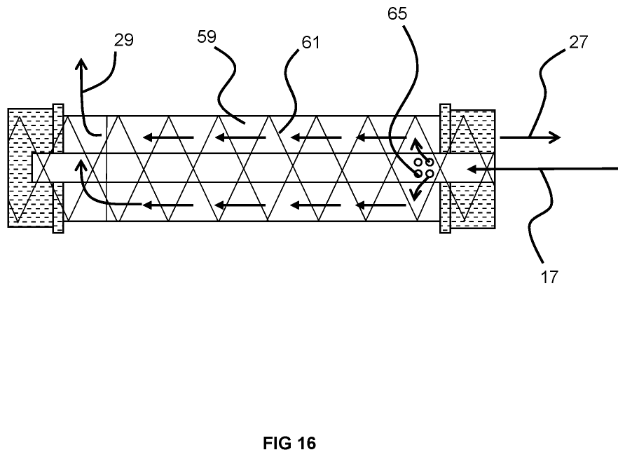

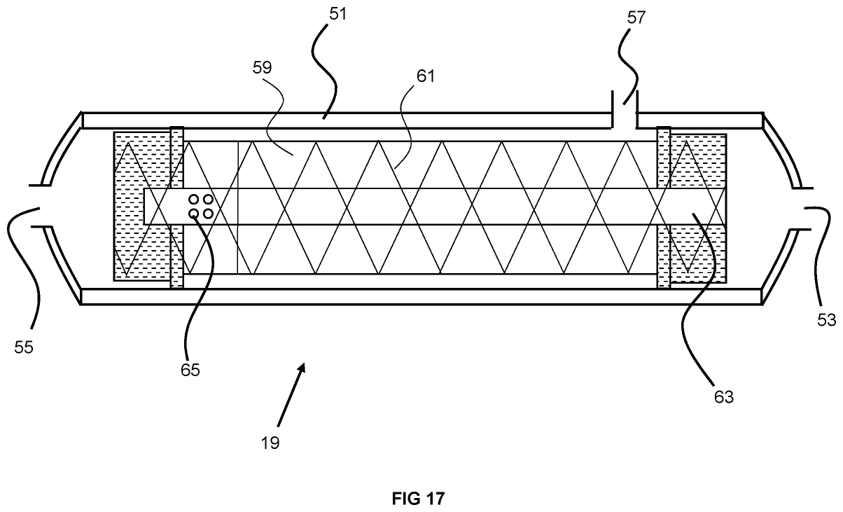

In contrast to the membrane device 19 of FIG. 13, in the membrane device of FIG. 15, the feed inlet 53 is disposed at an upstream end of the membrane device 19, the deoxygenated fuel outlet 57 is disposed on an outer circumferential surface of the membrane device 19 adjacent the downstream end of the membrane device 19, and the gaseous permeate outlet 55 is disposed at the upstream end of the membrane device 19. As seen in FIG. 16, the flow 17 of dissolved oxygen-containing liquid hydrocarbon fuel enters the membrane device 19 via the feed inlet 53 and flows into and along the hollow center tube 63. The dissolved oxygen-containing liquid hydrocarbon fuel exits the hollow center tube 63 via apertures 65 formed in the hollow center tube 63 adjacent the upstream end. The dissolved oxygen-containing liquid hydrocarbon fuel flows along the bundle 59 of composite hollow fibers 61 from the upstream end of the bundle 59 to the downstream end of the bundle 59. The flow of at least partially deoxygenated liquid hydrocarbon fuel 29 is withdrawn via the deoxygenated fuel outlet 57. The permeated oxygen flows in counter-current fashion, with respect to the flow of dissolved oxygen-containing liquid hydrocarbon fuel within the membrane device 19, to the upstream end of the membrane and is withdrawn as the flow of gaseous permeate 27 via the gaseous permeate outlet 55. Those of ordinary skill in the art will recognize that the combination of flow patterns described above for the membrane device 19 of FIG. 15 may be considered outwardly axially fed and counter-current.

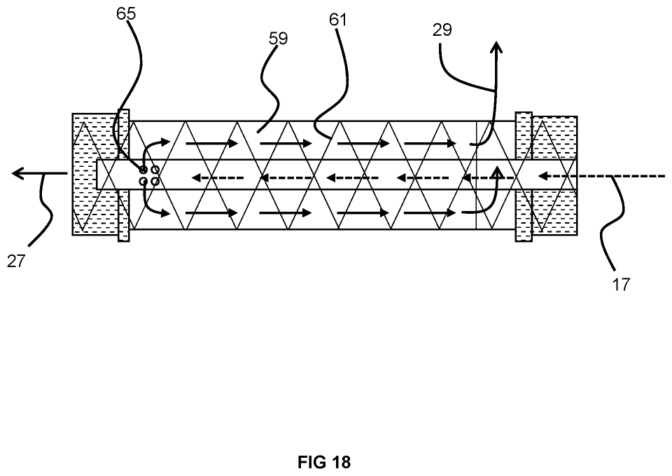

While the membrane device 19 of FIG. 17 may also be considered outwardly axially fed and counter-current, its specific configuration does not require that the gaseous permeate outlet 55 be disposed adjacent to the feed inlet 53, as is the case of the membrane device 19 of FIG. 15. In contrast to the membrane device 19 of FIG. 15, the feed inlet 53 of the membrane device of FIG. 17 is disposed at the upstream end of the membrane device 19. As seen in FIG. 18, the flow 17 of dissolved oxygen-containing liquid hydrocarbon fuel enters the membrane device 19 via the feed inlet 53 and flows into and along the hollow center tube 63. The dissolved oxygen-containing liquid hydrocarbon fuel exits the hollow center tube 63 via apertures 65 formed therein at a downstream end of the hollow center tube 63. The dissolved oxygen-containing liquid hydrocarbon fuel flows along the bundle 59 of composite hollow fibers 61 from the upstream end of the bundle 59 to the downstream end of the bundle 59. The flow of at least partially deoxygenated liquid hydrocarbon fuel 29 is withdrawn via the deoxygenated fuel outlet 57 is disposed on an outer circumferential surface of the membrane device 19 adjacent the downstream end thereof. The permeated oxygen flows in counter-current fashion, with respect to the flow of dissolved oxygen-containing liquid hydrocarbon fuel within the membrane device 19, to the upstream end of the membrane and is withdrawn as the flow of gaseous permeate 27 via the gaseous permeate outlet 55. In this case, the gaseous permeate outlet 55 is disposed at the upstream end of the membrane device 19. Because the feed inlet 53 and the gaseous permeate outlet 55 are disposed at opposite ends of the membrane device 19, manufacturing is simpler and fewer mechanical stresses are created at either end of the membrane device 19.

The directions of the flow of dissolved oxygen-containing liquid hydrocarbon fuel, the flow of permeate gas, and the flow of deoxygenated liquid hydrocarbon fuel, within the membrane device 19, are not limited to the embodiments of FIGS. 13-18. Indeed, any combination known in the field of liquid or gas separation membranes may be used such as co-current or counter-current. Typically, however, the permeate gas flow is counter-current to that of the flow of deoxygenated liquid hydrocarbon fuel with respect to the membrane because that configuration provides for the most efficient removal of oxygen. This is regardless of whether it is shell-fed or bore-fed.

Before it is combusted in the energy conversion device 21, the deoxygenated liquid hydrocarbon fuel in the conduit leading away from the deoxygenated fuel outlet 57 may be used to cool an apparatus or fluid.

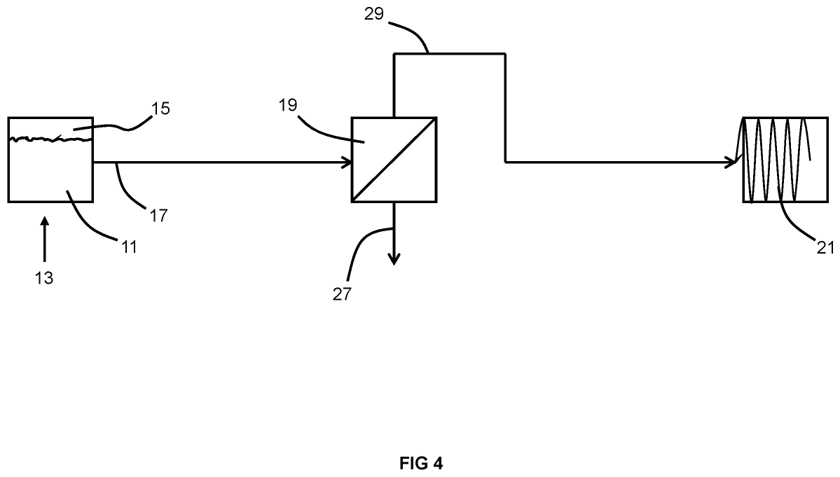

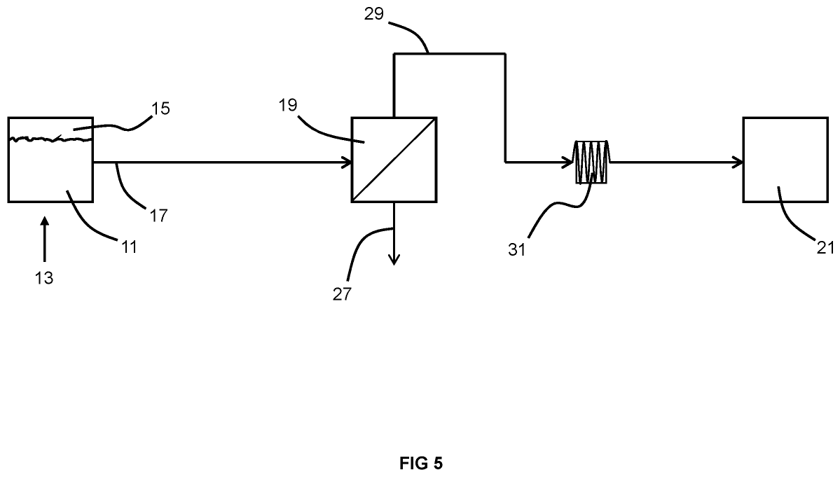

For example, the at least partially deoxygenated liquid hydrocarbon fuel from the membrane device 19 may exchange heat with a heat sink prior to being fed to the energy conversion device 21. In this manner, the heat sink is cooled and the at least partially deoxygenated liquid hydrocarbon fuel is heated. As shown in FIG. 4, the heat sink may be part of the energy conversion device 21 wherein a conduit containing the flow of at least partially deoxygenated fuel 29 is optionally coiled around the heat sink/energy conversion device 21. This may be advantageous for an energy conversion device 21 whose temperature is controlled. Alternatively and as shown in FIG. 5, the heat sink may be equipment 31 that does not form part of the energy conversion device, but is operatively associated with the energy conversion device 21 in an integrated system including the energy conversion device 21. While any technique known in the field of heat transfer using heat sinks may be used to cool the heat sink using the at least partially deoxygenated liquid hydrocarbon fuel from the membrane device 19, typically, the conduit is in thermal contact with the mass of the heat sink (for example, being coiled around it) so heat is transferred from the heat sink 31 to the conduit and then from the conduit to the at least partially deoxygenated liquid hydrocarbon fuel.

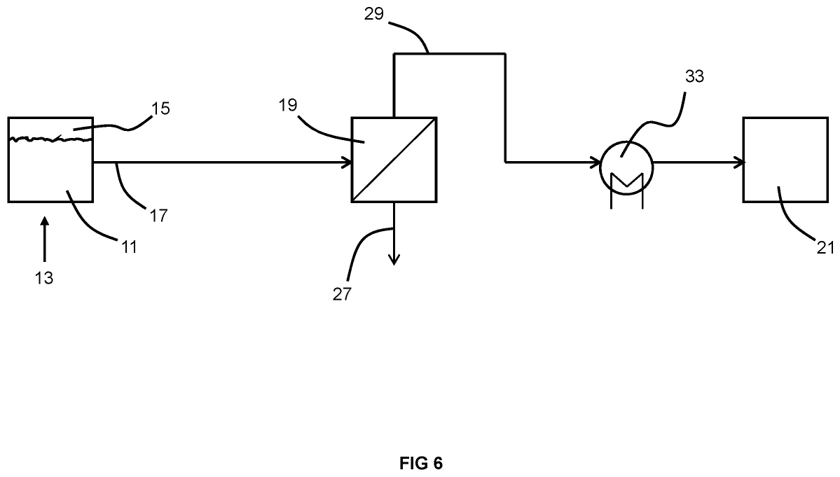

In a second example, and as illustrated in FIG. 6 the at least partially deoxygenated liquid hydrocarbon fuel from the membrane device 19 may exchange heat with another fluid associated with the energy conversion device 21 using a heat exchanger 33 disposed downstream of the conduit X and upstream of the energy conversion device 21. In this manner, the fluid (such as air) is cooled and the at least partially deoxygenated liquid hydrocarbon fuel is heated. The cooled fluid may be used to cool components of the energy conversion device 21. While any heat exchanger known in the field of heat transfer may be used to exchange heat between the fluid and the at least partially deoxygenated liquid hydrocarbon fuel, typically it is a plate/fin type heat exchanger or a shell and tube type heat exchanger.

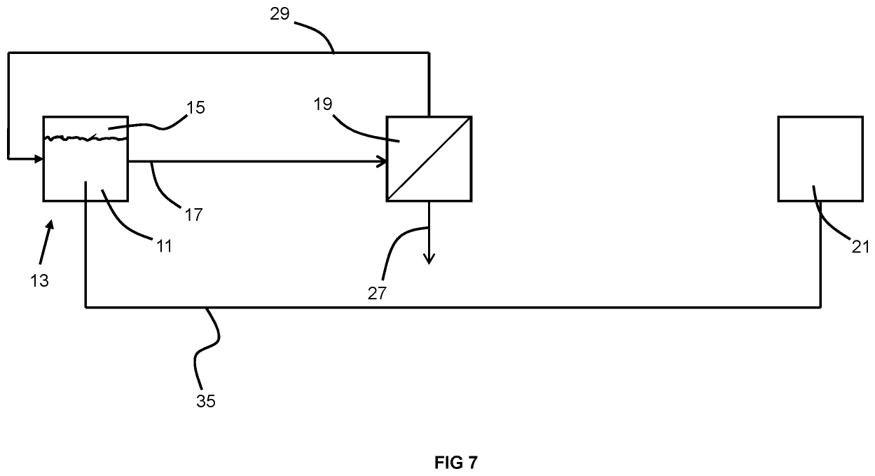

As shown in FIG. 7, before it is ultimately combusted in the energy conversion device 21, the at least partially deoxygenated liquid hydrocarbon fuel from the membrane device 19 may be returned to the tank 13. In this case, a feed conduit 35 from the tank 13 may be used to feed liquid hydrocarbon fuel from the tank 13 to the energy conversion device 21. Optionally, only a portion of the at least partially deoxygenated fuel from the membrane device 19 is returned to the tank 13 while a different portion or the remainder is fed to the energy conversion device 21 without being first returned to the tank 13.

Alternatively and as illustrated in FIGS. 1-6 and 8-10, the entirety of the at least partially deoxygenated liquid hydrocarbon fuel is fed to the energy conversion device 21 without first being returned to the tank 13.

The oxygen partial pressure differential across the membrane from the first side to the second side may be increased in any of three different ways.

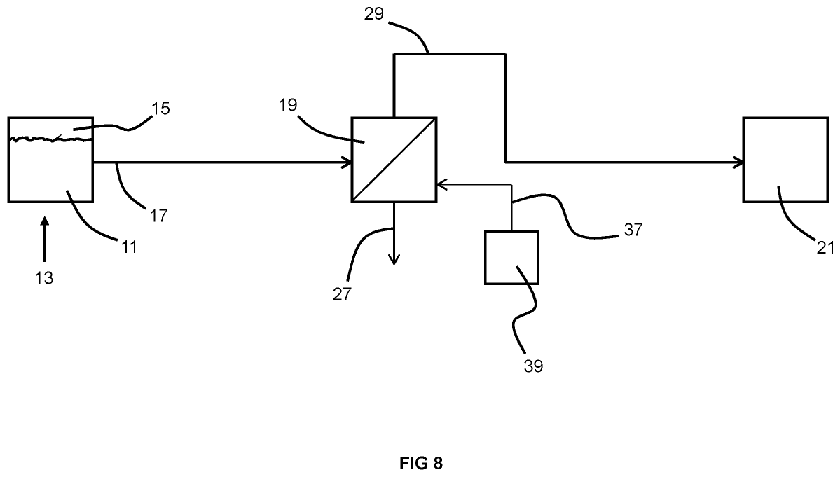

In a first embodiment and as shown in FIG. 8, a flow 37 of a low-oxygen sweep gas is fed to the membrane device 19 where it is routed to the second side of the membrane. Because it has a low oxygen concentration, the partial pressure differential for oxygen across the membrane from the first side to the second side is increased. Thus, the driving force of the membrane is increased and a relatively greater amount of oxygen dissolved in the dissolved oxygen-containing liquid hydrocarbon fuel permeates across the membrane from the first side to the second side. Preferred sweep gases include the inert gases nitrogen or argon, containing less than 10 ppm oxygen, or even less than 2 ppm oxygen. The source 39 of such an inert sweep gas may be one or more compressed gas cylinders, an inert gas generator. A typical inert gas generation system is a pressure swing adsorption system (PSA) which produces nitrogen from air. Alternatively, a membrane-based air separation system may be used to produce, from air, nitrogen-enriched air that is subsequently purified in a PSA to remove amounts of oxygen. Instead of an inert gas, the source 39 of the sweep gas may be a vaporized portion of the deoxygenated liquid hydrocarbon fuel.

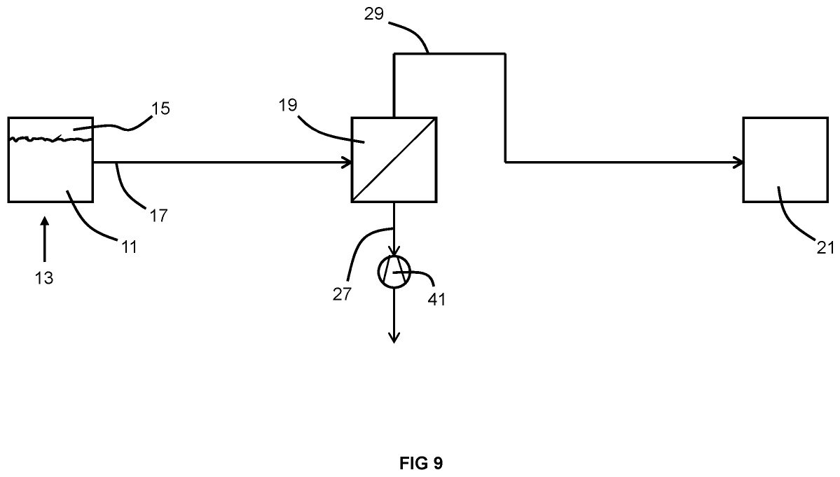

In a second embodiment and as illustrated in FIG. 9, a vacuum pump 41 is placed in downstream fluid communication with the permeate gas outlet of the membrane device 19. Due to the vacuum that is thus pulled on the permeate gas outlet, and consequently, the second side of the membrane, the oxygen partial pressure on the second side is decreased because the overall pressure on the second side of the membrane is decreased.

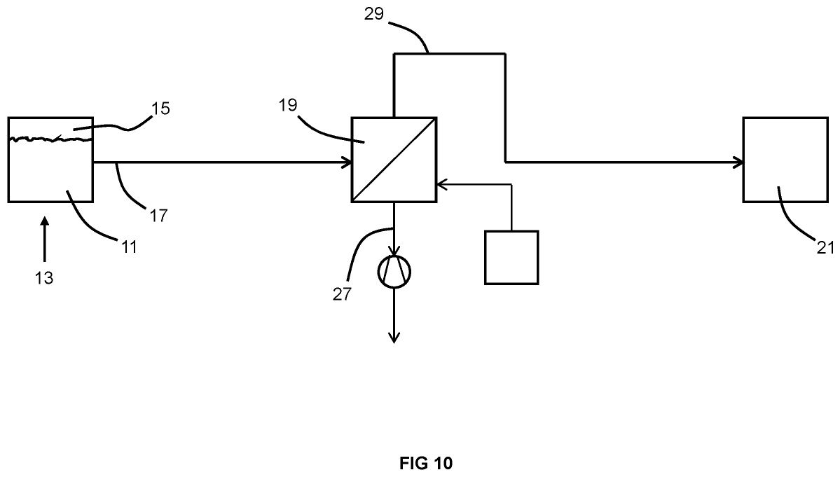

In a third embodiment and as shown in FIG. 10, both the aforementioned flow 37 of sweep gas and vacuum pump 23 may be used in combination. This may allow the oxygen partial pressure on the second side of the membrane to reach levels as low as 1 ppm.

Whether or not the aforementioned embodiments for increasing the oxygen partial pressure differential across the membrane are used, typically at least 30% of the dissolved oxygen is removed from the dissolved oxygen-containing liquid hydrocarbon fuel through permeation across the membrane. More typically 50% of the dissolved oxygen is removed, and even more typically, 90% of the dissolved oxygen is removed.

The energy conversion device includes any apparatus, system, or installation in which a liquid hydrocarbon fuel, at some point prior to eventual combustion in the energy conversion device, acquires sufficient heat to support autoxidation reactions and coking if no attempts are made to at least partially remove the dissolved oxygen. Such energy conversion devices include but are not limited to power generation facilities (such as those utilizing a boiler, steam turbine, or gas turbine), engines, and furnaces. Typically, the energy conversion device is an engine, including but not limited to those used for ground transportation (such as for cars, trucks, busses, or other motorized heavy equipment), those used for non-transportation machinery (such as generators, boilers, or mills), and those used for aircraft. Specific types of aircraft engines include reciprocating (piston) engines as well as turbine engines such as turbojet, turboprop, turbofan and turboshaft engines.

The specific type of liquid hydrocarbon fuel that may be at least partially deoxygenated by the membrane device is driven by the type of energy conversion device. Specific types of liquid hydrocarbon fuels includes but is not limited to: kerosene, gasoline, gasoline/ethanol mixtures, and ethanol. In the case of an energy conversion device that is an aircraft engine, specific types of hydrocarbon fuels include jet fuel (such as Jet-A type kerosene-based jet fuel) and aviation gasoline (also called avgas). Aviation gasoline, for example, has a higher octane rating than automotive gasoline to allow higher compression ratios, power output, and efficiency at higher altitudes.

A particular type of liquid hydrocarbon fuel is jet fuel. Jet fuels are chemically complex mixtures having a wide variety of molecules with different number of carbons and may have more than thousands of species. The major categories of jet fuel components include alkanes, cycloalkanes (naphthenes), aromatics, and alkenes. Alkanes (such as dodecane, tetradecane, and isooctane) are the most abundant components and account for 50-60% by volume of the jet fuel. Cycloalkanes (such as methylcyclohexane, tetralin, and decalin) and aromatics (such as toluene, xylene, and naphthalene) represent 20-30% by volume, and alkenes account for less than 5%.

When the invention is implemented in association with a power generation facility or furnace, the liquid hydrocarbon fuel may be preheated through heat exchange with a hot fluid, such as steam or flue gas, prior to being combusted. By preheating the fuel prior to combustion, more energy or power can be produced by the power generation facility or furnace for a given amount of fuel in comparison to a power generation facility or furnace not utilizing fuel preheating. Looked at another way, preheating the fuel prior to combustion allows less fuel to be combusted for producing a given amount of energy power by the energy conversion device. Any technique known in the field of power generation or furnaces utilizing preheated fuel may be used for achieving the fuel preheating in the invention. For example, the fuel may be preheated in a shell and tube heat exchanger. Regardless of the specific mode of fuel preheating, because the fuel has been at least partially deoxygenated, buildup of coking deposits occurs less rapidly at the outlet of the fuel injector of the burner or at portions of a burner in close proximity to fuel-rich regions of the flame from the burner. This is because the relative lack of oxygen decreases the potential for or degree of coking of the liquid hydrocarbon fuel after heating the at least partially deoxygenated fuel to temperatures supporting autoxidation reactions. This allows the fuel to be preheated to temperatures exceeding 250° F., 300° F., 425° F., or even temperatures reaching as high as 900° F. By reducing the rate at which coking deposits forms, maintenance for removal of such deposits may be performed less frequently. As a result, there is less down-time for the burner or for the power generation facility or furnace because they will be taken out of service less frequently or for shorter periods of time.

When the invention is implemented in association with an aircraft engine, the fuel deoxygenated by the membrane device may first be used as a cooling medium for receiving heat form a heat exchanger or heat sink associated with the aircraft, such as electronic control systems of the aircraft. Alternatively, it may be used as a cooling medium for cooling air used in a system for cooling electronic control systems of the aircraft.

When the invention is implemented in association with engine used either for aircraft or other purpose, the fuel deoxygenated by the membrane device may be used as a cooling medium for the engine itself. As discussed above with respect to power generation facilities and furnaces, preheating fuel prior to combustion in the engine allows more energy or power to be produced by the engine for a given amount of fuel or allows less fuel to be consumed for a given amount of energy or power produced by the engine. Again as discussed above, because the fuel has been at least partially deoxygenated, buildup of coking deposits occurs less rapidly at or adjacent to the fuel injectors of the engine. This allows the fuel to be preheated to temperatures exceeding 250° F., 300° F., 425° F., or even temperatures reaching as high as 900° F. By reducing the rate at which coking deposits forms, maintenance for removal of such deposits may be performed less frequently. As a result, there is less down-time for the engine because they will be taken out of service less frequently or for shorter periods of time.

The composite hollow fiber membrane of the membrane device includes a porous hollow fiber substrate made of one or more PAEKs and an ultra-thin layer of an amorphous perfluoro polymer that is superimposed on the porous hollow fiber substrate. PAEK represent a class of semi-crystalline engineering thermoplastics with outstanding thermal properties and chemical resistance. One of the representative polymers in this class is poly(ether ether ketone), sometimes referred to as PEEK, which has a reported continuous service temperature of approximately 250° C. PAEK polymers are virtually insoluble in all common solvents at room temperature. These properties make PAEK ideal material for contact with liquid fuels.

The preferred porous PAEK substrates are semi-crystalline. Namely, a fraction of the poly(aryl ether ketone) polymer phase is crystalline and is thus not subject to a chemical modification. A high degree of crystallinity is preferred since it imparts solvent resistance and improves thermo-mechanical characteristics to the article. In some embodiments of this invention the degree of crystallinity is at least 15%, preferably at least 25%, most preferably at least 36%. When pre-formed, shaped porous substrates are utilized to form the composite membranes of this invention, the porous substrate may be formed by any method known in the art.

Each of the PAEKs is independently selected from the formula:

[—Ar′—CO—Ar″]ₙ

wherein Ar′ ad Ar″ are aromatic moieties and n is an integer from 20 to 500. At least one of the aromatic moieties contains a diarylether or diarylthioether functional group which is a part of the polymer backbone.

Typically, each PAEK is selected from the homopolymers of the following repeating units:

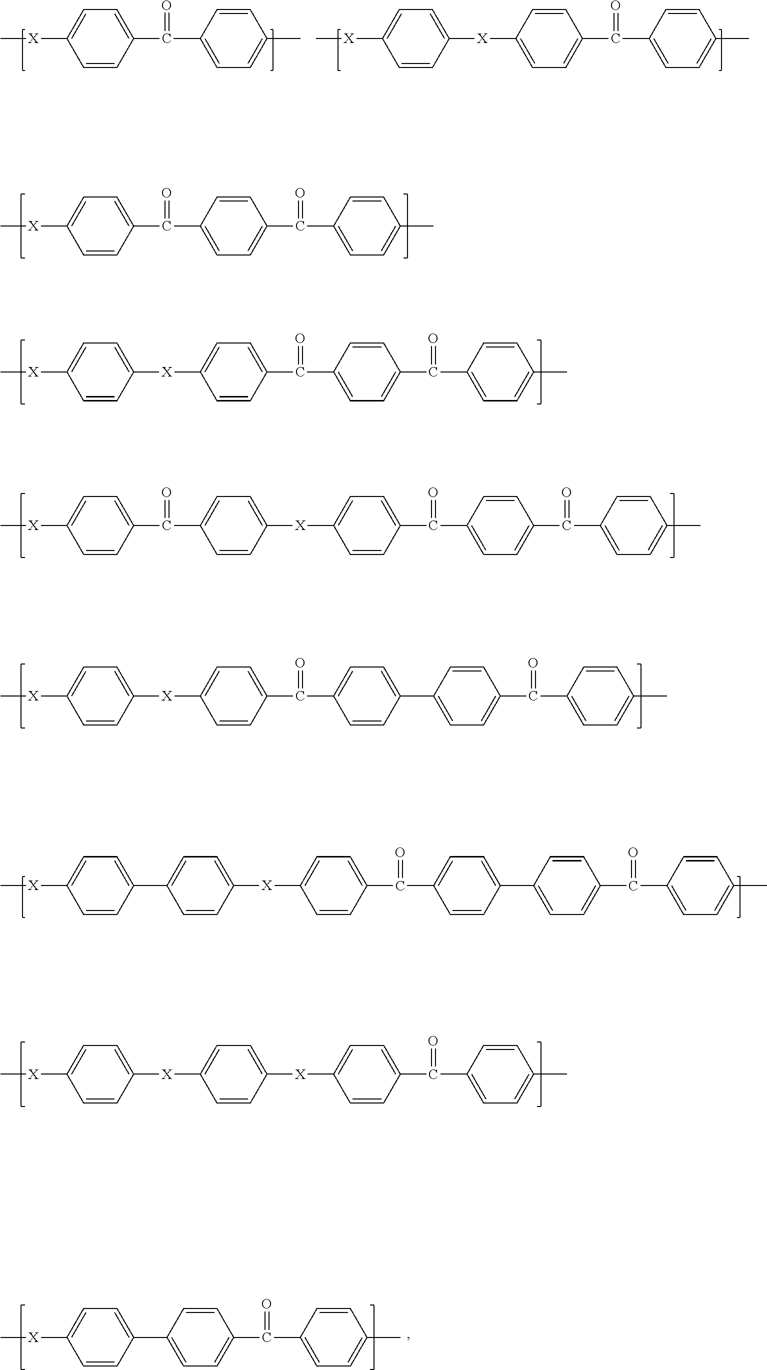

wherein x is an ether unit.

The PAEK(s) can have a weight average molecular weight in the range of 20,000 to 1,000,000 Daltons, preferably between 30,000 to 500,000 Daltons.

The preferred PAEKs are semi-crystalline polymers that are not soluble in organic solvents at conventional temperatures. Two typical such PAEKs include poly(ether ether ketone) (i.e., PEEK) and poly(ether ketone) (i.e., PEK), each available from Victrex Corporation under the trade name of Victrex. Another typical such PAEK is poly(ether ketone ketone) (i.e., PEKK) available from Oxford Performance Materials under the trade name OXPEKK.

Typically, the porous PAEK substrate is formed by melt processing, for example, by the methods disclosed in U.S. Pat. Nos. 6,887,408, 7,176,273, 7,229,580, 7,368,526, and 9,610,547. Certain version of porous PAEK hollow fibers are available commercially from Air Liquide Advanced Technologies US.

The composite membranes are prepared by forming a perfluoro hydrocarbon layer on top of a porous PAEK substrate. Optionally, the perfluoro hydrocarbon is chemically attached to the PAEK polymer of the substrate. While this may be achieved by any way known in the field of polymer grafting, perfluoro polymers with functional amino groups can be chemically attached to the PAEK substrate through reaction with ketone groups in the backbone of poly(aryl ether ketone) polymer.

Particular examples of suitable perfluoro polymers include Teflon AF amorphous polymers, such as AF1600 or AF 2400 (originally manufactured by DuPont), Hyflon polymers, such AD60 and AD80 (manufactured by Solvay), and Cytop perfluorobutenyl vinyl ether (manufactured by Asahi Glass). Other perfluoro polymers include amorphous polymers, such as copolymers of perfluoro (2-methlene-4,5-dimethyl-1,3-dioxolane) and perfluoro (2-methylene-1,3-dioxolane) as described in Y. Okamoto et al., Journal of Membrane Science, Volume 471, page 412-419, 2014.

The perfuoro polymer layer can be formed from a single amorphous perfluoro polymer, or from a blend of two or more different amorphous perfluoro polymers. In one example, the blend is comprised of Teflon AF1600 and Hyflon AD 60, as described in U.S. Pat. No. 6,723,152, incorporated herein by reference in its entirety.

The composite hollow fibers used to form membranes of this invention preferably have an outside diameter from about 50 to about 5,000 micrometers, more preferably from about 80 to about 1,000 micrometers, with a wall thickness from about 10 to about 1,000 micrometers, preferably from 20 to 500 micrometers. While the term “composite hollow fiber membrane” is a singular tense noun, those of ordinary skill in the art will readily recognize that such a term as used in the art encompasses a plurality of composite hollow fibers assembled into a single mass. Such artisans will further readily recognize that, for bore-fed membranes, the totality of each of the bores of the hollow composite fibers constitutes the first side of the membrane (in the case of bore-fed membranes) and the totality of each of the outer surfaces of the hollow composite fibers constitutes the second side of the membrane. Such artisans will readily recognize that the opposite is equally true for shell-fed membranes. In the membrane of the invention, the membrane typically includes from 100 to 1,000,000 hollow fibers, more typically from 100 to 500,000 hollow fibers constructed into module. Also, the dissolved oxygen-containing liquid hydrocarbon fuel may be at least partially deoxygenated by more than one membrane. For that matter, it may be at least partially deoxygenated by two or more membranes arranged in parallel or in series.

The composite hollow fiber membrane preferably exhibits an oxygen permeance between 30 GPU and 5000 GPU, more preferably between 100 GPU and 2000 GPU. The permeance or the flow flux of the gas component through the membrane is expressed as 1 gas permeation unit (GPU)=10⁻⁶ cm³(S.T.P)/(s·cm²·cm Hg), and it is derived by the following equation:

$$J = \frac{{P}^{*}}{δ} ( {xP}_{f} - {yP}_{p} ) = \vec{{P}^{*}} ( {xP}_{f} - {yP}_{p} )$$

### Where:

J=the volume flux of a component (cm³(S.T.P)/cm²·s);
P*=membrane permeability that measures the ability of the membrane to permeate gas (cm³(S.T.P).cm/(s·cm²·cm Hg)); [symbol]
=membrane permeance (cm³(S.T.P.)/(s·cm²·cm Hg))*;
δ=the membrane thickness (cm);
χ=the mole fraction of the gas in the feed stream;
y=the mole fraction of the gas in the permeate stream;
P_{f}=the feed-side pressure (cm Hg);
P_{ρ}=the permeate-side pressure (cm Hg).
Additional details regarding methods of calculating the permeance can be found in “Technical and Economic Assessment of Membrane-based Systems for Capturing CO₂ from Coal-fired Power Plants” by Zhai, et al. in Presentation to the 2011 AlChE Spring Meeting, Chicago, Ill.

The hydrocarbons in the liquid hydrocarbon have a greater than zero permeance across the membrane. In order to limit the loss of these hydrocarbons due to permeation across the membrane along with the dissolved oxygen, the amorphous perflouro polymer or blend of such polymers is utilized because permeation of the hydrocarbons is greatly inhibited. The liquid hydrocarbon fuel often contains a blend of many hydrocarbons of different chain lengths, especially as seen in the description of jet fuel above. Because of this, it is impractical to characterize the permeation of each of these separate molecules across the membrane. Propane is a heavy hydrocarbon with a relatively high vapor pressure in comparison to the hydrocarbon components in the liquid hydrocarbon fuel. Those of ordinary skill in the art will recognize that the permeance of propane can be conveniently measured in the lab with much high accuracy. Therefore, propane is a good surrogate for assessing the degree to which the hydrocarbons permeate across the membrane and whether the membrane exhibits a satisfactorily low permeance of such hydrocarbons. While the membrane typically has a room temperature oxygen permeance of 30-5000 GPU (and a minimum permeance of at least 70 GPU, typically at least 100 GPU, and more typically at least 130 GPU), in order to limit the hydrocarbon loss through simultaneous permeation, the membrane should have a room temperature propane permeance lower than 15 GPU, and more typically lower than 10 GPU, or even lower than 8 GPU. A desired propane permeance may be achieved by varying the thickness of the thin layer of amorphous perfluoro polymer.

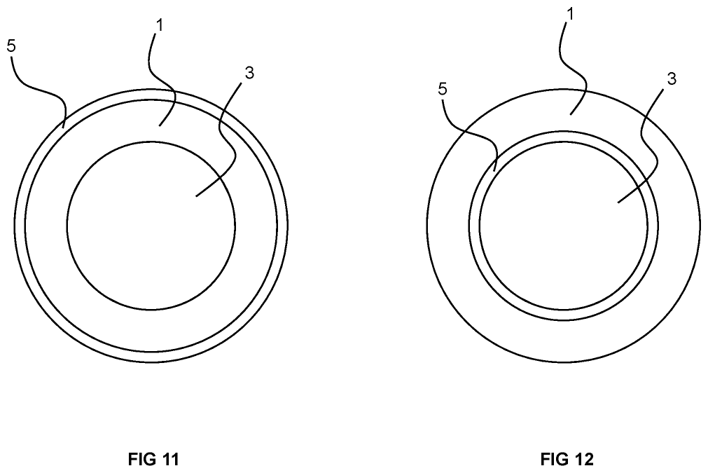

The perfluoro polymer layer can be applied to PAEK porous substrate by methods known in the art such as solution based coating, such as that disclosed in U.S. Pat. No. 6,540,813. As shown in FIG. 11, the amorphous perfluoro polymer layer 5 may be deposited on an outer surface of the porous PAEK substrate 1. In this case, the liquid hydrocarbon fuel is placed in contact with the amorphous perfluoro polymer layer 5 and amounts of the dissolved oxygen permeate across the amorphous perfluoro polymer layer 5 and the porous PAEK substrate 1 to the bore 3. Those skilled in the art will recognize that this is the shell-side fed type of membrane device. Alternatively and as shown in FIG. 12, the amorphous perfluoro polymer layer 5 may be deposited on an inner surface of the porous PAEK substrate 1. In this case, the liquid hydrocarbon fuel is placed in contact with the amorphous perfluoro polymer layer 5 and amounts of the dissolved oxygen permeate across the the amorphous perfluoro polymer layer 5 and the porous PAEK substrate 1 to the region outside of the hollow fiber. Those skilled in the art will recognize that this is the bore-side fed type of membrane device.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

What is claimed is:

1. A method for producing oxygen-depleted liquid hydrocarbon fuel for combustion in an energy conversion device in which the oxygen-depleted liquid hydrocarbon fuel is used as a cooling medium, comprising the steps of:
feeding a flow of liquid hydrocarbon fuel containing dissolved oxygen into a membrane device comprising a composite hollow fiber membrane that is comprised of a porous PAEK substrate with a thin layer of an amorphous perfluoro polymer superimposed thereon;
allowing the fed flow of dissolved oxygen-containing liquid hydrocarbon fuel to come into contact with a first side of the membrane, thereby permeating at least some of the dissolved oxygen across the membrane from the first side to a second side of the membrane;
withdrawing a flow of at least partially deoxygenated liquid hydrocarbon fuel from the membrane device that is depleted of dissolved oxygen in comparison to the flow of the dissolved oxygen-containing liquid hydrocarbon fuel that is fed to the membrane device; and
withdrawing a gas stream from the membrane device containing the permeated oxygen that is removed from the fed flow of the dissolved oxygen-containing liquid hydrocarbon fuel.

2. The method of claim 1, further comprising the step of transferring heat from the energy conversion device, a heat sink, or a fluid to the withdrawn flow of the at least partially deoxygenated liquid hydrocarbon fuel so as to cool the energy conversion device and heat the at least partially deoxygenated liquid hydrocarbon fuel.

3. The method of claim 2, wherein the deoxygenated liquid hydrocarbon fuel is heated to a temperature of at least 250° F.

4. The method of claim 2, wherein the deoxygenated liquid hydrocarbon fuel is heated to a temperature of at least 300° F.

5. The method of claim 2, wherein the deoxygenated liquid hydrocarbon fuel is heated to a temperature of at least 425° F.

6. The method of claim 2, wherein the deoxygenated liquid hydrocarbon fuel is heated to a temperature of at least 900° F.

7. The method of claim 2, wherein heat is transferred from the energy conversion device to the deoxygenated liquid hydrocarbon fuel.

8. The method of claim 1, wherein a positive partial pressure differential for oxygen across the membrane from the first side to the second side is increased by applying a vacuum is applied to the second side of the membrane device.

9. The method of claim 8, wherein the positive partial pressure differential for oxygen across the membrane from the first side to the second side is increased by feeding a sweep gas is fed to the second side of the membrane device.

10. The method of claim 1, wherein a positive partial pressure differential for oxygen across the membrane from the first side to the second side is increased by feeding a sweep gas to the second side of the membrane device.

11. The method of claim 10, wherein the sweep gas is an amount of liquid hydrocarbon fuel, before or after deoxygenation at the membrane device, that has been allowed to vaporize.

12. The method of claim 10, wherein the sweep gas is:
nitrogen generated by an on board air separation system; or
nitrogen or argon from an inert gas generator.

13. The method of claim 1, wherein the withdrawn gas stream is directed into a head space of a fuel tank from which the flow of dissolved oxygen-containing liquid hydrocarbon fuel was obtained.

14. The method of claim 1, wherein at least some of the dissolved oxygen-containing liquid hydrocarbon fuel fed to the membrane device also permeates, in the form of vapor, across the membrane from the first side to the second side along with the permeating oxygen.

15. The method of claim 14, wherein the membrane is characterized by a room temperature permeance of propane of lower than 15 GPU.

16. The method of claim 14, wherein the membrane is characterized by a room temperature permeance of propane of lower than 10 GPU.

17. The method of claim 14, wherein the membrane is characterized by a room temperature permeance of propane of lower than 8 GPU.

18. The method of claim 14, wherein the membrane is characterized by a room temperature permeance of oxygen of at least 70 GPU.

19. The method of claim 1, wherein the thin layer of amorphous perfluoro polymer is superimposed upon an outer surface of the PAEK substrate.

20. The method of claim 1, wherein the thin layer of amorphous perfluoro polymer is superimposed on an inner surface of the hollow fiber that forms the first side of the membrane.

21. The method of claim 1, wherein the fed flow of dissolved oxygen-containing liquid hydrocarbon fuel is pumped by a pump to the membrane device at a pressure between 100 and 400 psig.

22. The method of claim 1, wherein:
the energy conversion device is an aircraft engine;
the dissolved oxygen-containing liquid hydrocarbon fuel is jet fuel;
the fed flow of dissolved oxygen-containing liquid hydrocarbon fuel is obtained from an aircraft jet fuel tank; and
said method further comprises the step of returning, to the aircraft jet fuel tank, the withdrawn flow of at least partially deoxygenated liquid hydrocarbon fuel.

23. The method of claim 1, wherein:
the energy conversion device is an aircraft engine;
the dissolved oxygen-containing liquid hydrocarbon fuel is jet fuel;
the fed flow of dissolved oxygen-containing liquid hydrocarbon fuel is obtained from an aircraft jet fuel tank; and
said method further comprises the step of feeding, to the aircraft engine, the withdrawn flow of at least partially deoxygenated liquid hydrocarbon fuel.

24. The method of claim 1, wherein the dissolved oxygen-containing liquid hydrocarbon fuel is selected from the group consisting of kerosenes, gasolines, biofuels, ethanol, and mixtures of a gasoline and ethanol.
